(19) United States
(12) Patent Application Publication
(10) Pub. No.: US 2024/0003855 A1
(43) Pub. Date: Jan. 4, 2024

(54) METHOD FOR EXTRACTING FEATURE PATH SIGNALS OF PIPELINE ULTRASONIC HELICAL GUIDED WAVES

(71) Applicant: Nanjing University of Aeronautics and Astronautics, Nanjing (CN)

(72) Inventors: Zhenghua QIAN, Nanjing (CN); Zhi QIAN, Nanjing (CN); Peng LI, Nanjing (CN); Chen YANG, Nanjing (CN)

(21) Appl. No.: 18/176,432

(22) Filed: Feb. 28, 2023

(30) Foreign Application Priority Data
Jun. 30, 2022 (CN) 2022107652354

(51) Int. Cl. G01N 29/46; G01N 29/04

(52) U.S. Cl. CPC G01N 29/46; G01N 29/041; G01N 2291/2636; G01N 2291/0427; G01N 2291/023

(57) ABSTRACT

The present disclosure belongs to the technical field of ultrasonic non-destructive testing, and discloses a method for extracting feature path signals of pipeline ultrasonic helical guided waves. The method includes: transforming a nonlinear wave number relationship of a pipe wall into a linear form by first order Taylor expansion, the approximation being reasonable under narrow band excitation; on this basis, establishing multimodal and multipath guided wave propagation over-complete data sets, and obtaining a modal weight factor and a path weight factor through a single-layer neural network algorithm; and multiplying the modal weight factor by the multimodal data set to separate a plurality of groups of unimodal signals from a whole signal, and multiplying the path weight factor by the multipath data set to extract unimodal feature path signals. The present disclosure can effectively extract unimodal unipath guided wave feature signals and improve the signal identification, and has broad prospects.

### TECHNICAL FIELD

The present disclosure relates to the technical field of ultrasonic non-destructive testing, in particular to a method for extracting feature path signals of pipeline ultrasonic helical guided waves.

### BACKGROUND

Since 1985, ultrasonic guided wave technology has been widely used in the national economy because of the long-range testing and non-destructive properties, and has an extremely prominent position especially in pipeline health monitoring. lamb waves form helically propagated guided waves in pipe walls, which may accurately reconstruct the wall thickness of pipe segments within a certain range, so they have broad application prospects. However, the multimodal and dispersive characteristics of lamb guided waves lead to poor signal identification, and the helical propagation in the pipe walls may produce a large number of path overlap. Thus, how to find an effective algorithm that may extract multiple groups of features paths of a unimodal, so as to identify valid signals, has become one of the key problems of subsequent laminar imaging and non-destructive testing.

Signal identification is the basis of industrial ultrasonic guided wave non-destructive testing and evaluation. In order to meet the imaging requirements, many related signal processing algorithms, such as wavelet transform, variational modal decomposition and dispersion compensation, have achieved many important results in recent years. These results are mainly used for denoising and extracting main frequency components, which are very general, but no systematic research has been done to develop multipath overlap separation algorithms for the specific problems of helical guided waves. Thus, there are great limitations in the application, and features can only be extracted qualitatively based on empirical human judgment. This leads to human error and waste of time cost. Moreover, in order to prevent path overlap, only sparse arrays may be selected, so that the imaging accuracy is not high. To change this situation, the present disclosure tried a technology for extracting feature path signals of pipeline ultrasonic helical guided waves, carried out corresponding pipeline testing experiments, and extracted corresponding signals for verification, thus fully proving the feasibility of the present disclosure.

### SUMMARY

In order solve the problems in the prior art, the present disclosure provides a method for extracting feature path signals of pipeline ultrasonic helical guided waves. By means of the method, unimodal multipath signal extraction of helical guided wave experimental signals collected by an ultrasonic transducer may be achieved in the case of sparse or dense arrays, such that feature data with considerable identification are provided for subsequent non-destructive testing and evaluation, and the problems mentioned in the background are solved.

To realize the above objective, the present disclosure provides the following technical solution: a method for extracting feature path signals of pipeline ultrasonic helical guided waves includes the following steps:
S1, constructing a windowed cosine function as excitation;
S2, calculating a unimodal unipath signal response;
S3, constructing over-complete multimodal and multipath data sets;
S4, separating out unimodals through a single-layer neural network algorithm, so as to obtain a unimodal signal;
S5, constructing an over-complete unimodal specific path data set; and
S6, extracting the feature path signals.

Preferably, in step S1, the windowed cosine function ƒ(t)=w(t)cos(ωt) is modulated as an excitation function of guided waves, w(t) denoting a window function, ω denoting an angular frequency, t denoting a time term; after the excitation function is propagated by a distance x, a response signal is:

$$f ( x , t ) = \frac{1}{2 π} {\int }_{- ∞}^{+ ∞} F ( ω ) {e}^{i ( ω t - k ( ω ) x )} d ω ,$$

F(ω)=∫_{-∞}^{+∞}ƒ(t)^{-ωt}dt denoting a Fourier transform form of the excitation function ƒ(t), k(ω) denoting the wave number.

Preferably, in step S2, the calculating a unimodal unipath signal response specifically includes: in the case that an excitation function is known, performing first order linear expansion on the wave number k(ω) at a center frequency ω₀ based on a Taylor's formula, so as to obtain k(ω)≈k₀+k₁(ω−ω₀)
where

$${k}_{0} = \frac{{ω}_{0}}{{c}_{p} ( {ω}_{0} )} , {k}_{1} = \frac{1}{{c}_{g} ( {ω}_{0} )} ,$$

cₚ(ω₀) denotes a phase velocity of lamb waves at the center frequency ω₀, c_{g}(ω₀) denotes a group velocity at the frequency, and f(x,t)=A·w(t−k₁x)cos(ω₀t−k₀x) obtained by substituting a linear expression of k(ω) into f(x,t), A denoting an amplitude of a signal envelope; and
letting t₁=k₁x denote time for signal propagation by a distance x, such that the unimodal unipath signal response is

$$f ( {t}_{1} , t ) = A \cdot w ( t - {t}_{1} ) cos [ {ω}_{0} ( t - {t}_{1} ) + {ω}_{0} {t}_{1} - \frac{{k}_{0}}{{k}_{1}} {t}_{1} ] ,$$

and letting

$$ϕ = {ω}_{0} {t}_{1} - \frac{{k}_{0}}{{k}_{1}} {t}_{1}$$

denote a phase variation.

Preferably, the over-complete multimodal and multipath data sets include all modals and all propagation paths of a received signal, with a data set matrix D=[D₁, D₂, . . . , Dₙ, . . . , D_{N}], where n=1, 2, . . . , N, denoting an order of a modal;
each unimodal data set Dₙ includes a series of different propagation path elements, respectively denoted as [L₁, L₂, . . . , Lₚ, . . . , Lₚ] where p=1, 2, . . . , P, denoting a pth different path, each path passes through different pipe wall boundary conditions in a propagation process, a phase of each path also varies with time, and each path data set is further divided into Q phase elements, denoted as [ϕ₁, ϕ₂, . . . , ϕ_{q}, . . . , ϕ_{Q}] where q=1, 2, . . . , Q; and
assuming that the received signal includes I time series and each phase element ϕ_{q} is a column vector of I×1, based on the data set, an expression of a qth phase element in a pth path of an nth-order modal is:

ϕ_{q}^{n,p}=Ω·w(t−kₙ₁lₚ)cos[ω₀(t−kₙ₁lₚ)+ω_{q}].

Preferably, step S4 specifically includes: based on the multimodal and multipath data sets, expressing an actual multimodal multipath received signal as y=Dx+e, y denoting the actual received signal, with an order of I×1, D denoting a data set matrix, with an order of I×(n·p·q), x denoting a multimodal weight factor, with an order of (n·p·q)×1, e denoting an error term, with an order of I×1;
performing modal separation, and rewriting y=Dx+e as:

$$y = [ {D}_{1 ,} {D}_{2} , … , {D}_{n} , … , {D}_{N} ] [ \begin{matrix}{x}_{1} \\ {x}_{2} \\ … \\ {x}_{n} \\ {x}_{N}\end{matrix} ] + e ,$$

Dₙ denoting a unimodal data set, with an order of I×(p·q), xₙ denoting a unimodal weight factor, with an order of (p·q)×1; and
transforming solving y=Dx+e into solving an optimization problem min∥y−Dx∥₂², solving by constructing a single-layer neural network model, so as to obtain the unimodal weight factor xₙ, and obtaining the unimodal signal by calculating yₙ−Dₙ·xₙ.

Preferably, the constructing an over-complete unimodal specific path data set specifically includes: determining all propagation paths for the unimodal signal included in a signal, and establishing the unimodal specific path data set, the data set including feature paths and phase elements, the unimodal specific path data set being L′=[L′₁, L′₂, . . . , L′ₘ, . . . , L′_{M}], m=1, 2, . . . , M, denoting m different paths, M<P, each path being further divided into Q phase elements, denoted as [ϕ₁, ϕ₂, . . . ϕ_{q}, . . . , ϕ_{Q}], q=1, 2, . . . , Q.

Preferably, in step S6, the extracting the feature path signals specifically includes: based on the unimodal specific path data set, expressing a unimodal multipath received signal as: y′=L′x′+e′, y′ denoting a unimodal received signal, with an order of I×1, L′ denoting a data set matrix, with an order of I×(m·q), x′ denoting a multipath weight factor, with an order of e′ denoting an error term, with an order of I×1;
performing path separation and rewriting y′=L′x′+e′ as

$${y}^{′} = [ {L}_{1 ,}^{′} {L}_{2}^{′} , … , {L}_{m}^{′} , … , {L}_{M}^{′} ] [ \begin{matrix}{x}_{1}^{′} \\ {x}_{2}^{′} \\ … \\ {x}_{m}^{′} \\ {x}_{M}^{′}\end{matrix} ] + {e}^{′} ,$$

L′ₘ denoting a unipath data set, with an order of I×q, x′ₘ denoting a unipath weight factor, with an order of q×1; and transforming solving y′=L′x′ into solving an optimization problem min∥y′−L′x′∥₂², solving y′=L′x′ by constructing a single-layer neural network model, and calculating y′ₘ=L′ₘ·xₘ after the unipath weight factor x′ₘ is obtained, so as to obtain a unimodal mth path signal, such that feature path signal extraction is completed.

The present disclosure has the following beneficial effects:
(1) According to the present disclosure, first order Taylor expansion is performed on the nonlinear wave number relationship, retaining only a linear term. Since an excitation signal is mostly a narrow-band windowed pulse signal, the approximation is reasonable. The linear approximation can suppress the dispersion of guided waves and improve the signal identification.
(2) Starting from the guided wave excitation function in a general form, the over-complete multimodal and multipath data sets are established, and the expression of each element in the data sets includes the propagation distance and the phase variation, so that unimodal multipath signal extraction can be realized.
(3) The present disclosure is a breakthrough in pipeline helical guided wave testing, can be used in the field of pipeline ultrasonic helical guided wave non-destructive testing as a basic technique for pipeline helical guided wave signal identification, and has broad application prospects as a basic signal processing technique for subsequent imaging.

### BRIEF DESCRIPTION OF DRAWINGS

FIG. 1 illustrates a schematic structural diagram of ring arrays for pipeline non-destructive testing according to an embodiment of the present disclosure;

FIG. 2 illustrates a schematic diagram of pipeline helical guided waves expanded into a planar propagation form according to an embodiment of the present disclosure;

FIG. 3 illustrates an algorithm flow diagram of a method for extracting feature path signals of pipeline ultrasonic helical guided waves according to the present disclosure;

FIG. 4 illustrates diagrams of a group of typical multipath multimodal original signals and reconstructed signals selected based on wave number linearization technology according to the present disclosure; and

FIG. 5 illustrates schematic diagrams of six groups of unimodal unipath signals extracted through a method according to the present disclosure.

### DETAILED DESCRIPTION OF EMBODIMENTS

The technical solutions in the embodiments of the present disclosure will be clearly and completely described below with reference to the accompanying drawings in the embodiments of the present disclosure. Apparently, the described embodiments are merely a part of the embodiments of the present disclosure, rather than all the embodiments. In general, the pipeline array forms and signal excitation general expressions according to the embodiments as described in the accompanying drawings may be configured and implemented in different ways. Accordingly, the following detailed description of the embodiments of the present application provided in conjunction with the accompanying drawings is not intended to limit the protection scope of the present application as claimed, but is merely representative of selected embodiments of the present application. Based on the embodiments of the present application, all other embodiments obtained by a person skilled in the art without involving any inventive effort fall within the protection scope of the present application.

### Example 1

A method for extracting feature path signals of pipeline ultrasonic helical guided waves includes: a windowed cosine function ƒ(t)=w(t)cos(ωt) is modulated as an excitation function of guided waves, where w(t) denotes a window function, ω denotes an angular frequency, and t denotes a time term. After the excitation function is propagated by a distance x, a response signal may be denoted as:

$$f ( x , t ) = \frac{1}{2 π} {\int }_{∞}^{+ ∞} F ( ω ) {e}^{i ( ω t - k ( ω ) x )} d ω ,$$

where F(ω)=∫_{-∞}^{+∞}ƒ(t)e^{-iωt}dt denotes a Fourier transform form of the excitation function ƒ(t), and k(ω) denotes the wave number, may be obtained through a lamb wave dispersion curve, and is in a nonlinear form.

First order linear expansion is performed on the wave number k(ω) at a center frequency ω₀ based on a Taylor's formula, so as to obtain k(ω)≈k₀+k₁(ω−ω₀), where

$${k}_{0} = \frac{{ω}_{0}}{{c}_{p} ( {ω}_{0} )} , {k}_{1} = \frac{1}{{c}_{g} ( {ω}_{0} )} ,$$

cₚ(ω₀) denotes a phase velocity of lamb waves at the center frequency ω₀, and c_{g}(ω₀) denotes a group velocity at the frequency. A linear expression of k(ω) is substituted into f(x,t) based on the Fourier transform correlation theorem, and f(x,t)=A·w(t−k₁x)cos(ω₀ t−k₀x) is obtained upon simplification, where A denotes the amplitude of a signal envelope. By letting t₁=k₁x denote the time for signal propagation by a distance x, f(x,t) may be rewritten as

$$f ( {t}_{1} , t ) = A \cdot w ( t - {t}_{1} ) cos [ {ω}_{0} ( t - {t}_{1} ) + {ω}_{0} {t}_{1} - \frac{{k}_{0}}{{k}_{1}} {t}_{1} ] ,$$

letting

$$ϕ = {ω}_{0} {t}_{1} - \frac{{k}_{0}}{{k}_{1}} {t}_{1}$$

denote a phase variation. When unknown boundary conditions such as pits or inclusions exist in the pipe wall, both A and φ are changed, so the two are both unknowns. k₁ is also an unknown before the material of the pipe wall is known.

Through the above derivation, a unimodal unipath signal response is obtained. In the propagation process of the pipeline helical guided waves, an actual received signal at a receiving position of a transducer is a sum of the above response signals. The technical means of the present disclosure is to extract unimodal unipath guided waves from the whole signal by using the above derivation. A specific solution algorithm includes:

A1. Before signal separation is formally performed, prior propagation information of the needed modal guided waves is acquired, that is, a group of unimodal signals with known propagation paths are measured. The propagation paths of the group of signals may not include any defects. The value of k₁ is obtained by

$${k}_{1} = \frac{{t}_{1}}{x} .$$

A2. Multimodal and multipath guided wave propagation over-complete data sets are established, and a modal weight factor and a path weight factor are obtained through a single-layer neural network algorithm.

A3. Through combinations of the two weight factors (multiplying the modal weight factor by the multimodal data set to separate a plurality of groups of unimodal signals from the whole signal, and multiplying the path weight factor by the multipath data set to extract unimodal feature path signals), the unimodal signals are extracted from multimodal results firstly, and then unipath signals are extracted from a unimodal data set.

In step A2, the multimodal and multipath over-complete data sets are firstly established, and the data sets need to include all modals and all propagation paths of the received signal. The specific design form of the data sets includes:
a data set matrix D=[D₁, D₂, . . . , Dₙ, . . . , D_{N}] where n=1, 2, . . . , N, denoting an order of a modal. Each unimodal data set Dₙ includes a series of different propagation path elements, respectively denoted as [L₁, L₂, . . . , Lₚ, . . . , Lₚ], where p=1, 2, . . . , P, denoting a pth different path. Each path may pass through different pipe wall boundary conditions in the propagation process, some are zero-defect, some are defective, so that the phase also changes with time. Each path data set is further divided into Q phase elements, denoted as [ϕ₁, ϕ₂, . . . ϕ_{q}, . . . , ϕ_{Q}], where q=1, 2, . . . , Q.

Assuming that the received signal of a receiving transducer includes I time series and each phase element ϕ_{q} is a column vector of I×1, based on the whole data set, an expression of a qth phase element in a pth path of an nth-order modal may be written as: ϕ_{q}^{n,p}=Ω·w(t−kₙ₁lₚ)cos[ω₀(t−kₙ₁lₚ)+ω_{q}], where t denotes a time series and is a column vector of I×1, Ω denotes a 2-norm normalization factor, kₙ₁ denotes a value of k₁ of the nth-order modal, Iₚ denotes the length of the pth path, and φ_{q} denotes a variation of the qth phase.

After a final data set and the expressions of all elements in the data set are obtained, an actual multimodal multipath received signal may be expressed as: y=Dx+e where y denotes the actual received signal, with an order of I×1, D denotes a data set matrix, with an order of I×(n·p·q), x denotes a multimodal weight factor, with an order of (n·p·q)×1 and e denotes an error term, with an order of I×1. During modal separation, the above expression may be rewritten as

$$y = [ {D}_{1 ,} {D}_{2} , … , {D}_{n} , … , {D}_{N} ] [ \begin{matrix}{x}_{l} \\ {x}_{2} \\ … \\ {x}_{n} \\ {x}_{N}\end{matrix} ] + e ,$$

where Dₙ denotes a unimodal data set, with an order of I×(p·q), and xₙ denotes a unimodal weight factor, with an order of (p·q)×1.

The modal weight factor in step A2 may be obtained by constructing the single-layer neural network algorithm, so as to obtain the unimodal weight factor xₙ, and the unimodal signal may be obtained by calculating yₙ=Dₙ·xₙ. Path extraction is similar, but in order to realize path separation, the paths included in the received signal need to be known in advance to extract specific paths. The process specifically includes:

Firstly, unimodal separation is realized in the whole received signal by using the above modal separation method, all propagation paths for the unimodal signal included in the signal are determined, and the unimodal data set is established. The data set includes feature paths and phase elements. The data set is denoted as L′=[L′₁, L′₂, . . . , L′ₘ, . . . , L′_{M}] where m=1, 2, . . . , M, denoting m different paths, and M<P. Each path is further divided into Q phase elements, denoted as [ϕ₁, ϕ₂, . . . ϕ_{q}, . . . , ϕ_{Q}], where q=1, 2, . . . , Q. After a path data set is obtained, an actual unimodal multipath received signal may be expressed as: y′=L′x′+e′, where y′ denotes the unimodal received signal, with an order of I×1, L′ denotes a data set matrix, with an order of I×(m·q), x′ denotes a multipath weight factor, with an order of (m·q)×1, and e′ denotes an error term, with an order of I×1. During path separation, the above expression may be rewritten as:

$${y}^{′} = [ {L}_{1 ,}^{′} {L}_{2}^{′} , … , {L}_{m}^{′} , … , {L}_{M}^{′} ] [ \begin{matrix}{x}_{1}^{′} \\ {x}_{2}^{′} \\ … \\ {x}_{m}^{′} \\ … \\ {x}_{M}^{′}\end{matrix} ] + {e}^{′} ,$$

where L′ₘ denotes a unipath data set, with an order of I×q, and x′ₘ, denotes a unipath weight factor, with an order of q×1. Solving feature path extraction is an optimization problem min∥y′−L′x′∥₂² which is solved by constructing the single-layer neural network model, so as to obtain the unipath weight factor x′ₘ, and a unimodal mth path signal may be obtained by calculating y′ₘ=L′ₘ·xₘ.

The present disclosure can effectively suppress the dispersion of guided waves, extract unimodal unipath guided wave feature signals, and improve the signal identification. As a basic signal processing means, this method can be widely used in a large number of industrial environments such as industrial oil pipelines and power plant pipelines, and has broad prospects.

### Example 2

A method for extracting feature path signals of pipeline ultrasonic helical guided waves includes: a pipeline ultrasonic helical guided wave non-destructive testing platform is built, and a ring array acquisition form is designed; several groups of prior defect-free signals are made to facilitate the establishment of over-complete multimodal and multipath data sets; during a formal acquisition experiment, feature extraction is performed on some acquired signals that are difficult to identify, especially guided wave signals with a large number of path overlap and multimodal mixing, through the method according to the present disclosure. Thus, the identification is improved.

In the experiments covered by the present disclosure, the pipeline ultrasonic non-destructive testing platform includes a PC, a general source signal generator DG4102, a power amplifier Aigtek-2022H, a circular piezoelectric plate transducer with a resonant frequency of 200 KHZ, a pipeline to be tested, and an oscilloscope MDO-3024. Firstly, a group of windowed cosine functions ƒ(t)=w(t) cos(ωt) are modulated by the signal generator as an excitation function of guided waves. A window function selected according to this embodiment of the present disclosure is a Gaussian window function

$$w ( t - {t}_{0} ) = {e}^{- \frac{{( t - {t}_{0} )}^{2}}{2 {σ}^{2}}} ,$$

where t₀=1.25e⁻⁵ denotes initial time offset, and σ=4.9744e⁻⁶ is a bandwidth factor for controlling the width of the window function. Therefore, for the excitation function designed according to this embodiment, all of the time t in the aforementioned content needs to be replaced with t−t₀ in actual operation. A voltage signal is amplified by the power amplifier and transferred to the piezoelectric transducer to excite a trigger signal, the trigger signal is then received by an acquisition probe and transferred to the oscilloscope, and the oscilloscope is controlled by a computer for signal acquisition and storage.

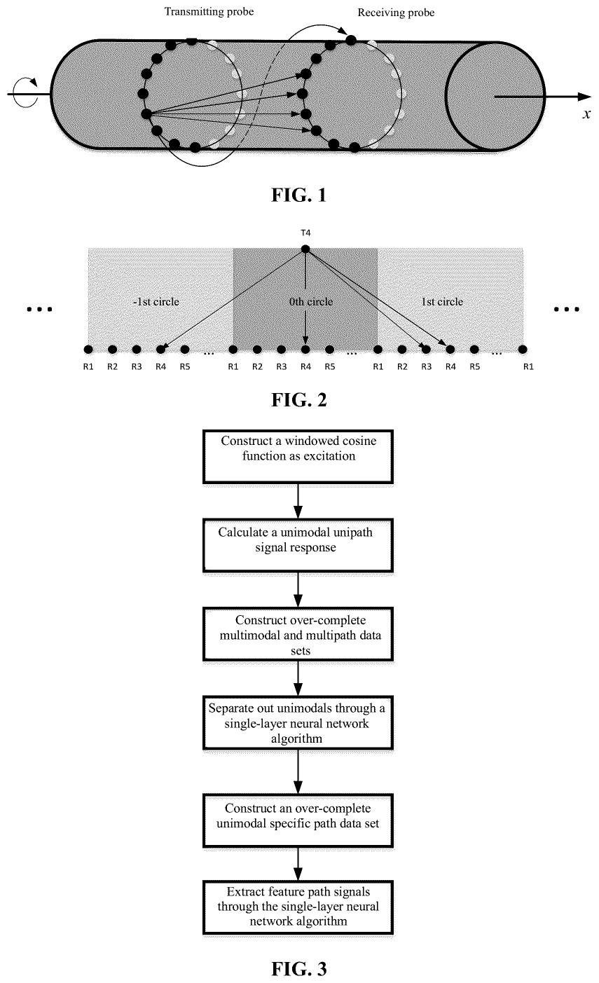

As shown in FIG. 1, the specific testing target is an oil pipeline being 1.5 m long, with an outer diameter of 219 mm and a wall thickness of 6 mm. A testing distance of 30 cm is selected from a middle section of the pipeline, and ring arrays are arranged at two ends for acquisition experiments. The arrays are in a one-transmitting and multi-receiving form, and the number of probes may be set according to actual demands. The main purpose of the present disclosure is to extract feature signals, so that specific details of the layout of the arrays may not be considered.

Further, an excitation transducer may produce omnidirectional S0 and A0 modes at a frequency of 200 k, traveling helically along the wall of the pipeline. The pipe wall may be expanded into the plane as shown in FIG. 2 for easy visualization. Because of the circumferential continuity of the pipe wall, the corresponding plane is equivalent to infinite expansion. Taking a propagation path of a T4-R4 embodiment selected by the present disclosure as an example, there is not only modal diversity but also a large number of path overlap. An actual received signal of a receiving probe R4 includes a plurality of paths in −1st, 0th and 1st circle planes. Similarly, in the 1st circle plane, T4-R3 has an approximate propagation distance as T4-R4 and thus may also have path overlap. Therefore, it is significant to perform unimodal separation and feature path extraction by the method according to the present disclosure so as to facilitate signal identification.

Further, a windowed cosine function ƒ(t)=w(t)cos(ωt) is modulated by the signal generator as an excitation function of guided waves, where w(t) denotes a window function, ω denotes an angular frequency, and t denotes a time term. After the excitation function is propagated by a distance x, a response signal may be denoted as:

$$f ( x , t ) = \frac{1}{2 π} {\int }_{- ∞}^{+ ∞} F ( ω ) {e}^{i ( ω t - k ( ω ) x )} d ω ,$$

where F(ω)=∫_{-∞}^{+∞}ƒ(t)^{-ωt}dt denotes a Fourier transform form of the excitation function ƒ(t), and k(ω) denotes the wave number, may be obtained through a lamb wave dispersion curve, and is in a nonlinear form.

Further, first order linear expansion is performed on the wave number WO at a center frequency ω₀ based on a Taylor's formula, so as to obtain k(ω)≈k₀+k₁(ω−ω₀), where

$${k}_{0} = \frac{{ω}_{0}}{{c}_{p} ( {ω}_{0} )} , {k}_{1} = \frac{1}{{c}_{g} ( {ω}_{0} )} ,$$

cₚ(ω₀) denotes a phase velocity of lamb waves at the center frequency ω₀, and c_{g}(ω₀) denotes a group velocity at the frequency. A linear expression of k(ω) is substituted into f(x,t) based on the Fourier transform correlation theorem, and f(x,t)=A·w(t−k₁x)cos(ω₀ t−k₀x) is obtained upon simplification, where A denotes the amplitude of a signal envelope. By letting t₁=k₁x denote the time for signal propagation by a distance x, f(x,t) may be rewritten as

$$f ( {t}_{1} , t ) = A \cdot w ( t - {t}_{1} ) cos [ {ω}_{0} ( t - {t}_{1} ) + {ω}_{0} {t}_{1} - \frac{{k}_{0}}{{k}_{1}} {t}_{1} ] ,$$

letting

$$ϕ = {ω}_{0} {t}_{1} - \frac{{k}_{0}}{{k}_{1}} {t}_{1}$$

denote a phase variation. When unknown boundary conditions such as pits or inclusions exist in the pipe wall, both A and φ are changed, so the two are both unknowns. k₁ is also an unknown before the material of the pipe wall is known. Finally, when the propagation path is known, ƒ(t₁,t)=A·w(t−t₁)cos[ω₀ (t−t₁)+φ], including three unknowns: A, φ, and k₁.

Further, through the above derivation, a unimodal unipath signal response is obtained. In the propagation process of the pipeline helical guided waves, an actual received signal at a receiving position of a transducer is a sum of the above response signals. The technical means of the present disclosure is to extract unimodal specific path guided waves from the whole signal by using the above derivation. A specific extraction algorithm includes:

A1. Before signal separation is formally performed, prior propagation information of the needed modal guided waves is acquired, that is, a group of unimodal signals with known propagation paths are measured. The propagation paths of the group of signals may not include any defects. The value of k₁ is obtained by

$${k}_{1} = \frac{{t}_{1}}{x} .$$

A2. Multimodal and multipath guided wave propagation over-complete data sets are established, and a modal weight factor and a path weight factor are obtained through a single-layer neural network algorithm.

A3. Through combinations of the two weight factors, the unimodal signals are extracted from multimodal results firstly, and then unipath signals are extracted from a unimodal data set.

In step A2, the multimodal and multipath over-complete data sets are firstly established, and the data sets need to include all modals and all propagation paths of the received signal. The specific design form of the data sets includes:
a data set matrix D=[D₁, D₂, . . . , Dₙ, . . . , D_{N}] where n=1, 2, . . . , N, denoting an order of a modal. Each unimodal data set Dₙ includes a series of different propagation path elements, respectively denoted as [L₁, L₂, . . . , Lₚ, . . . , Lₚ] where p=1, 2, . . . , P, denoting a pth different path. Each path may pass through different pipe wall boundary conditions in the propagation process, some are zero-defect, some are defective, so that the phase also changes with time. Each path data set is further divided into Q phase elements, denoted as [ϕ₁, ϕ₂, . . . ϕ_{q}, . . . , ϕ_{Q}], where q=1, 2, . . . , Q.

Assuming that the received signal of a receiving transducer includes I time series and each phase element ϕ_{q} is a column vector of I×1, based on the whole data set, an expression of a qth phase element in a pth path of an nth-order modal may be written as: ϕ_{q}^{n,p}=Ω·w(t−kₙ₁lₚ)cos[ω₀(t−kₙ₁lₚ)+ω_{q}], where t denotes a time series and is a column vector of I×1, Ω denotes a 2-norm normalization factor, kₙ₁ denotes a value of k₁ of the nth-order modal, Iₚ denotes the length of the pth path, and φ_{q} denotes a variation of the qth phase.

After a final data set and the expressions of all elements in the data set are obtained, an actual multimodal multipath received signal may be expressed as: y=Dx+e where y denotes the actual received signal, with an order of I×1, D denotes a data set matrix, with an order of I×(n·p·q), x denotes a multimodal weight factor, with an order of (n·p·q)×1 and e denotes an error term, with an order of I×1. During modal separation, the above expression may be rewritten as:

$$y = [ {D}_{1 ,} {D}_{2} , … , {D}_{n} , … , {D}_{N} ] [ \begin{matrix}{x}_{1} \\ {x}_{2} \\ … \\ {x}_{n} \\ … \\ {x}_{N}\end{matrix} ] + e ,$$

where Dₙ denotes a unimodal data set, with an order of I×(p·q), and xₙ denotes a unimodal weight factor, with an order of (p·q)×1.

The modal weight factor in step A2 may be solved by constructing the single-layer neural network algorithm, so as to obtain the unimodal weight factor xₙ, and the unimodal signal may be obtained by calculating yₙ=Dₙ·xₙ.

Path extraction is similar, but in order to realize path separation, the paths included in the received signal need to be known in advance to extract specific paths. The process specifically includes:

Firstly, unimodal separation is realized in the whole received signal by using the above modal separation method, all propagation paths for the unimodal signal included in the signal are determined, and the unimodal data set is established. The data set includes feature paths and phase elements. The data set is denoted as L′=[L′₁, L′₂, . . . , L′ₘ, . . . , L′_{M}], where m=1, 2, M, denoting m different paths, and M<P. Each path is further divided into Q phase elements, denoted as [ϕ₁, ϕ₂, . . . ϕ_{q}, . . . , ϕ_{Q}], where q=1, 2, . . . , Q. After a path data set is obtained, an actual unimodal multipath received signal may be expressed as: y′=L′x′+e′, where y′ denotes the unimodal received signal, with an order of I×1, L′ denotes a data set matrix, with an order of I×(m·q), x′ denotes a multipath weight factor, with an order of (m·q)×1, and e′ denotes an error term, with an order of I×1. During path separation, the above expression may be rewritten as:

$${y}^{′} = [ {L}_{1 ,}^{′} {L}_{2}^{′} , … , {L}_{m}^{′} , … , {L}_{M}^{′} ] [ \begin{matrix}{x}_{1}^{′} \\ {x}_{2}^{′} \\ … \\ {x}_{m}^{′} \\ … \\ {x}_{M}^{′}\end{matrix} ] + {e}^{′} ,$$

where L′ₘ denotes a unipath data set, with an order of I×q, and x′ₘ, denotes a unipath weight factor, with an order of q×1. Solving feature path extraction is an optimization problem min∥y′−L′x′∥₂² which is solved by constructing the single-layer neural network model, so as to obtain the unipath weight factor x′ₘ, and a unimodal mth path signal may be obtained by calculating y′ₘ=L′ₘ·xₘ.

Specifically, for the embodiment of the present disclosure, a group of typical signals including multiple modals and multiple paths are selected, as shown in FIG. 4, including a group of experimental original signals and non-dispersive signals reconstructed by the present disclosure using wave number linearization. In the actual industrial testing process, guided waves have the inherent characteristic of dispersion, and wave packet elongation may occur in the propagation process. Moreover, the receiving transducer is affected by the actual environment and manufacturing process, which may also produce certain oscillation and thus cause more clutter. The reconstructed signals in FIG. 4 suppress the phenomenon well and improve the signal identification.

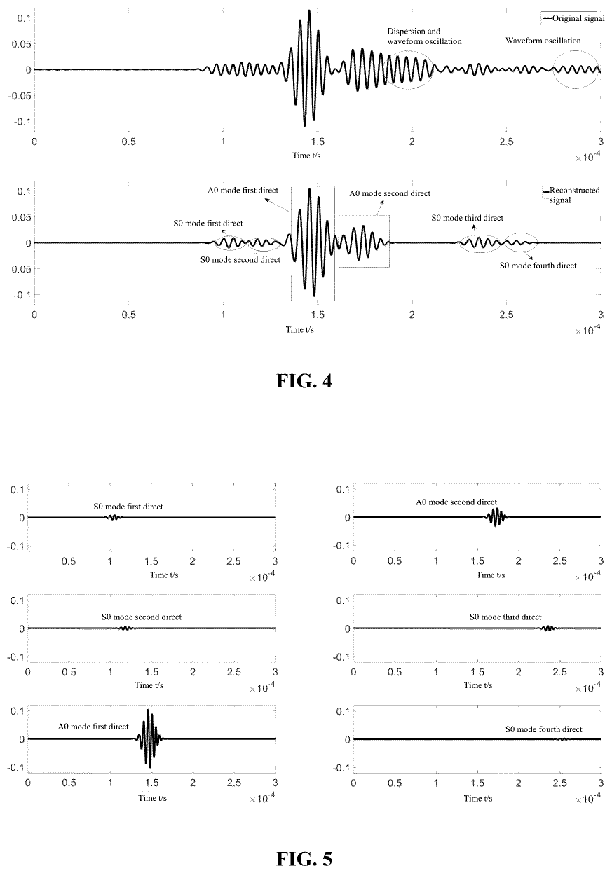

As shown in FIG. 5, modal separation and path separation are performed on the reconstructed signals in FIG. 4 based on the algorithm flow according to the present disclosure in FIG. 3. A total of six groups of unimodal unipath signals were separated from the reconstructed signals, including four groups of paths in S0 mode and two groups of paths in A0 mode respectively. The correctness and validity of the method according to the present disclosure may be fully verified by comparing the propagation group velocities and comparing with the original signals. The method may be used in the field of pipeline ultrasonic helical guided wave non-destructive testing, and has broad application prospects as a basic signal processing technique for subsequent imaging.

Although the present disclosure has been described in detail with reference to the foregoing embodiments, it will be apparent to those skilled in the art that changes may still be made to the technical solutions disclosed in the above-mentioned embodiments or equivalent substitutions may be made for some of the technical features. Any modifications, equivalent substitutions, improvements, etc. made within the spirit and principles of the present disclosure shall fall within the scope of the present disclosure.

1. A method for extracting feature path signals of pipeline ultrasonic helical guided waves, comprising the following steps:
S1, constructing a windowed cosine function as excitation;
S2, calculating a unimodal unipath signal response;
S3, constructing over-complete multimodal and multipath data sets;
S4, separating out unimodals through a single-layer neural network algorithm, so as to obtain a unimodal signal;
S5, constructing an over-complete unimodal specific path data set; and
S6, extracting the feature path signals.

2. The method for extracting feature path signals of pipeline ultrasonic helical guided waves according to claim 1, wherein in step S1, the windowed cosine function ƒ(t)=w(t) cos(ωt) is modulated as an excitation function of guided waves, w(t) denoting a window function, ω denoting an angular frequency, t denoting a time term; after the excitation function is propagated by a distance x, a response signal is:
$$f ( x , t ) = \frac{1}{2 π} {\int }_{- ∞}^{+ ∞} F ( ω ) {e}^{i ( ω t - k ( ω ) x )} d ω ,$$
F(ω)=∫_{-∞}^{+∞}ƒ(t)^{-ωt}dt denoting a Fourier transform form of the excitation function ƒ(t), k (ω) denoting the wave number.

3. The method for extracting feature path signals of pipeline ultrasonic helical guided waves according to claim 1, wherein in step S2, the calculating a unimodal unipath signal response specifically comprises: in the case that an excitation function is known, performing first order linear expansion on the wave number k (ω) at a center frequency ω₀ based on a Taylor's formula, so as to obtain k(ω)≈k₀+k₁(ω−ω₀),
wherein
$${k}_{0} = \frac{{ω}_{0}}{{c}_{p} ( {ω}_{0} )} , {k}_{1} = \frac{1}{{c}_{g} ( {ω}_{0} )} ,$$
cₚ(ω₀) denotes a phase velocity of lamb waves at the center frequency ω₀, c_{g}(ω₀) denotes a group velocity at the frequency, and f(x,t)=A·w(t−k₁x)cos(ω₀ t−k₀x) is obtained by substituting a linear expression of k(ω) into f(x,t), A denoting an amplitude of a signal envelope; and
letting t₁=k₁x denote time for signal propagation by a distance x, such that the unimodal unipath signal response is
$$f ( {t}_{1} , t ) = A \cdot w ( t - {t}_{1} ) cos [ {ω}_{0} ( t - {t}_{1} ) + {ω}_{0} {t}_{1} - \frac{{k}_{0}}{{k}_{1}} {t}_{1} ] ,$$
and letting
$$φ = {ω}_{0} {t}_{1} - \frac{{k}_{0}}{{k}_{1}} {t}_{1}$$
denote a phase variation.

4. The method for extracting feature path signals of pipeline ultrasonic helical guided waves according to claim 1, wherein the over-complete multimodal and multipath data sets comprise all modals and all propagation paths of a received signal, with a data set matrix being D=[D₁, D₂, . . . , Dₙ, . . . , D_{N}], wherein n=1, 2, . . . , N, denoting an order of a modal;
each unimodal data set Dₙ comprises a series of different propagation path elements, respectively denoted as [L₁, L₂, . . . , Lₚ, . . . , Lₚ], wherein p=1, 2, . . . , P, denoting a pth different path, each path passes through different pipe wall boundary conditions in a propagation process, a phase of each path also varies with time, and each path data set is further divided into Q phase elements, denoted as [ϕ₁, ϕ₂, . . . ϕ_{q}, . . . , ϕ_{Q}], wherein q=1, 2, . . . , Q; and
assuming that the received signal comprises I time series and each phase element ϕ_{q} is a column vector of I×1, based on the data set, an expression of a qth phase element in a pth path of an nth-order modal is:
ϕ_{q}^{n,p}Ω·w(t−kₙ₁lₚ)cos[ω₀(t−kₙ₁lₚ)+ω_{q}].

5. The method for extracting feature path signals of pipeline ultrasonic helical guided waves according to claim 1, wherein step S4 specifically comprises: based on the multimodal and multipath data sets, expressing an actual multimodal multipath received signal as y=Dx+e, y denoting the actual received signal, with an order of I×1, D denoting a data set matrix, with an order of I×(n·p·q), x denoting a multimodal weight factor, with an order of (n·p·q)×1, e denoting an error term, with an order of I×1;
performing modal separation, and rewriting y=Dx+e as:
$$y = [ {D}_{1 ,} {D}_{2} , … , {D}_{n} , … , {D}_{N} ] [ \begin{matrix}{x}_{1} \\ {x}_{2} \\ … \\ {x}_{n} \\ … \\ {x}_{N}\end{matrix} ] + e ,$$
Dₙ denoting a unimodal data set, with an order of I×(p·q), xₙ denoting a unimodal weight factor, with an order of (p·q)×1; and
transforming solving y=Dx+e into solving an optimization problem min∥y−Dx∥₂², solving y=Dx by constructing a single-layer neural network model, so as to obtain the unimodal weight factor xₙ, and obtaining the unimodal signal by calculating yₙ−Dₙ·xₙ.

6. The method for extracting feature path signals of pipeline ultrasonic helical guided waves according to claim 1, wherein the constructing an over-complete unimodal specific path data set specifically comprises: determining all propagation paths for the unimodal signal comprised in a signal, and establishing the unimodal specific path data set, the data set comprising feature paths and phase elements, the unimodal specific path data set being L′=[L′₁, L′₂, . . . , L′ₘ, . . . , L′_{M}], m=1, 2, . . . , M, denoting m different paths, M<P, each path being further divided into Q phase elements, denoted as [ϕ₁, ϕ₂, . . . ϕ_{q}, . . . , ϕ_{Q}], q1, 2, . . . , Q.

7. The method for extracting feature path signals of pipeline ultrasonic helical guided waves according to claim 1, wherein in step S6, the extracting the feature path signals specifically comprises: based on the unimodal specific path data set, expressing a unimodal multipath received signal as: y′=L′x′+e′, y′ denoting a unimodal received signal, with an order of I×1, L′ denoting a data set matrix, with an order of I×(m·q), x′ denoting a multipath weight factor, with an order of (m·q)×1e′ denoting an error term, with an order of I×1;
performing path separation and rewriting y′=L′x′+e′ as:
$${y}^{′} = [ {L}_{1 ,}^{′} {L}_{2}^{′} , … , {L}_{m}^{′} , … , {L}_{M}^{′} ] [ \begin{matrix}{x}_{1}^{′} \\ {x}_{2}^{′} \\ … \\ {x}_{m}^{′} \\ … \\ {x}_{M}^{′}\end{matrix} ] + {e}^{′} ,$$
L′ₘ denoting a unipath data set, with an order of I×q, x′ₘ, denoting a unipath weight factor, with an order of q×1; and
transforming solving y′=L′x′ into solving an optimization problem min∥y′−L′x′∥₂², solving y′=L′x′ by constructing a single-layer neural network model, and calculating y′ₘ=L′ₘ·xₘ after the unipath weight factor x′ₘ is obtained, so as to obtain a unimodal mth path signal, such that feature path signal extraction is completed.
